(19) United States
(12) Patent Application Publication
(10) Pub. No.: US 2002/0106153 A1
(43) Pub. Date: Aug. 8, 2002

(54) Optical system for aligning a collimated beam

(75) Inventors: Li Wu, Fuxing Investment District (CN); Jiwu Ling, Fuxing Investment District (CN); Qiping Wang, Fuxing Investment District (CN); Shuyun Liu, Fuxing Investment District (CN); Hanqi Wu, Fuxing Investment District (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/017,080

(22) Filed: Dec. 14, 2001

(30) Foreign Application Priority Data
Dec. 14, 2000 (CN) 00135413.2
Jul. 3, 2001 (CN) 01113758.4

(51) Int. Cl. G02B 6/32

(52) U.S. Cl. 385/33; 385/31

(57) ABSTRACT

The invention provides an optical collimator assembly having an optical fiber for transmitting a beam of light, a lens for substantially collimating a beam of light received from the optical fiber, and a light transmissive element disposed to receive a beam of light from the lens for correcting an angular deviation in the beam of light received from the lens. If desired, two wedges are used to correct an angular deviation of a beam exiting a collimator, wherein the two wedges have a relative rotational angle with respect to each other. The invention further provides a method for making an array of collimators having output beams substantially parallel to an axis of the collimator, or lens or lens system.

### CROSS-REFERENCE TO RELATED APPLICATIONS

This applications claims priority from Chinese Patent Application No. 00135413.2 filed on Dec. 14, 2000 and Chinese Patent Application No. 01113758.4 filed on Jul 03,2001.

### MICROFICHE APPENDIX

Not Applicable

### FIELD OF THE INVENTION

The present invention generally relates to the field of optical collimators and in particular to an optical system for aligning a collimated beam.

### BACKGROUND OF THE INVENTION

Optical fibers have become increasingly important in many applications involving the transmission of light. After light is coupled into a fiber, it is transported to a desired location. When the optical fiber is terminated, light rays exiting the fiber are divergent, exiting the fiber within a narrow cone angle. The exiting light rays are then bent into the desired shape using one or more lenses. In prior art designs, various lens systems have been used to collimate the light.

In practice, the fibers used in optical systems are typically held in collimator assemblies which are easily aligned to an optical system. Collimators are optical devices used for producing beams of parallel rays of light or other radiation. They increase or decrease the size of and change the divergence or angular characteristics of light beams passed through them. A commercial collimator includes as its most fundamental components a sleeve in which a fiber end within a supporting ferrule is joined to a collimating lens by attaching the sides of the ferrule and the collimating lens to the interior bore of the sleeve. The following lenses are examples of lenses that can be used as collimating lenses: spherical lenses, aspherical lenses, and/or GRaded INdex (GRIN) lenses. GRIN lenses are produced under the trade name “SELFOC”; the mark is registered in Japan and owned by the Nippon Sheet and Glass Co. Ltd.

Another common practice is to couple an optical fiber to a lens by placing the optical fiber into a ferrule or fiber tube and joining an end face of the tube directly to a face of the lens by applying a layer of epoxy between them.

Collimators are employed in optical systems to provide optically well-characterized beams and to yield minimum insertion losses between the fibers and the optical systems.

However, one common problem with collimators is that there is always an offset between an axis of the fiber and an axis of the lens because of an alignment of the fiber within the ferrule. Furthermore, in order to reduce return losses at an end face of the fiber in the collimator, the end of the fiber is terminated with a flat planar surface that is not normal to the axis of the optical fiber. Typically, the flat surface on the slanted end of the optical fiber makes an angle of 82 degrees with the optical fiber axis. Such an angled surface is an additional factor in causing a light beam exiting from a collimator to make an angle to a known axis, such as an axis of the lens or an axis of the collimator housing, since the cone of radiated light is deflected so its axis is no longer aligned with the optical fiber-collimating lens axis.

It is an object of this invention to provide an optical system for aligning a collimated beam with an axis of a lens and optical fiber.

Another object of this invention is to provide a collimator that provides for low coupling losses to other optical elements.

It is a further object of the invention to provide an array of collimators having exit beams parallel to respective axes of the lenses and collimator housings.

### SUMMARY OF THE INVENTION

In accordance with the invention there is provided, an optical collimator assembly comprising an optical fiber for transmitting a beam of light, a lens for substantially collimating a beam of light received from the optical fiber, and a first light transmissive element disposed to receive a beam of light from the lens for correcting an angular deviation in a beam of light received from the lens, said angular deviation being a deviation from a common axis of the optical collimator assembly. The first light-transmissive element has two non-parallel surfaces defining a first angle therebetween, one of the two non-parallel surfaces is a receiving surface for receiving a beam of light from the lens and the other one of the two non-parallel surfaces is a transmissive surface for transmitting the beam of light.

In accordance with a further embodiment of the invention, the optical collimator assembly comprises a second light-transmissive element having two non-parallel surfaces defining a second angle therebetween, one of the two non-parallel surfaces being a receiving surface for receiving the beam of light from the first light-transmissive element and the other one of the two non-parallel surfaces being a transmissive surface for transmitting the beam of light, said first and second light-transmissive element being disposed such that the transmissive face of the first light-transmissive element abuts with the receiving surface of the second light-transmissive surface. The first and the second light-transmissive element are disposed about a common rotational axis defining a relative rotational angle between the first and the second light-transmissive element, said common rotational axis being substantially parallel to the common axis of the optical collimator assembly. The relative rotational angle is adjusted by relatively displacing the first and the second light-transmissive element about the common rotational axis.

In accordance with another embodiment of the present invention the first and the second light-transmissive element are powerless and non-birefringent.

In accordance with the invention there is further provided an optical collimator assembly comprising an optical fiber having an input end for receiving a beam of light and an output end for transmitting a beam of light, an optical fiber sleeve for holding the optical fiber, wherein the optical fiber sleeve and the optical fiber have parallel longitudinal axes and coplanar output end surfaces, a lens for substantially collimating a beam of light received from the output end of the optical fiber, and a first light-transmissive powerless non-birefringent element having a first light-receiving face and an opposed first light-transmitting face, said first receiving and first transmitting face being non-parallel, the light-transmissive powerless non-birefringent element so located and oriented so as to correct an angular deviation in a beam of light exiting the lens to provide an output beam that is substantially parallel to a common axis of the optical collimator assembly.

In accordance with another embodiment the optical collimator assembly further comprises a second light-transmissive powerless non-birefringent element having a second light-receiving face and an opposed second light-transmitting face, said second receiving and second transmitting face being non-parallel, the second light-transmissive powerless non-birefringent element being so disposed that the first transmitting face abuts the second receiving face, said first and second light-transmissive powerless non-birefringent element being disposed about a common rotational axis defining a relative rotational angle between the first and the second light-transmissive powerless non-birefringent element, said common rotational axis being substantially parallel to the common axis of the optical collimator assembly. The relative rotational angle is adjusted by relatively displacing the first and the second light-transmissive powerless non-birefringent element about the common rotational axis.

In accordance with another aspect of the invention there is further provided an array of collimators comprising the optical collimator assembly of the present invention.

### BRIEF DESCRIPTION OF THE DRAWINGS

Exemplary embodiments of the invention will now be described in conjunction with the following drawings wherein like numerals represent like elements, and wherein:

FIG. 1 shows a schematic side view of a typical optical collimator;

FIG. 2 shows a schematic presentation of an optical collimator assembly in accordance with an embodiment of the present invention;

FIG. 3 shows a schematic presentation of a collimator assembly in accordance with another embodiment of the present invention including a wedge supported in a wedge holder fastened to a collimator housing;

FIG. 4 shows a schematic side view of a collimator assembly in accordance with another embodiment of the present invention wherein two wedges are used to correct an angular deviation;

FIG. 5 shows a schematic side view of an alternative arrangement of two wedges wherein narrow ends and wider ends of the respective wedges abut on a same side resulting in a frustoconical/conical arrangement of the wedges;

FIG. 6 shows a schematic side view of the arrangement of wedges of FIG. 5 wherein the wedges are rotated by 180°;

FIG. 7 presents a schematic front view of two wedges to show the relative angle of rotation φ between the wedges more clearly;

FIG. 8 shows a schematic front view of a collimator housing in accordance with the invention wherein two wedges are fastened inside a sleeve;

FIG. 9 shows a schematic front view of a collimator housing in accordance with the invention wherein two wedges are fastened inside a collimator housing;

FIG. 10 shows a schematic side view of a collimator assembly in accordance with the invention wherein a wedge holder supporting two wedges is fastened to the collimator housing;

FIG. 11 shows a schematic top view of a substrate comprising an array of openings therethrough;

FIG. 12 shows a schematic side view of a collimator array and a standard collimator to align individual collimators of an array; and

FIGS. 13a and 13b show a schematic side and top view, respectively, of an array of collimators in accordance with another embodiment of the invention wherein an angular deviation of an output beam is corrected for each collimator of the array.

### DETAILED DESCRIPTION OF THE PREFERRED EMBODIMENTS

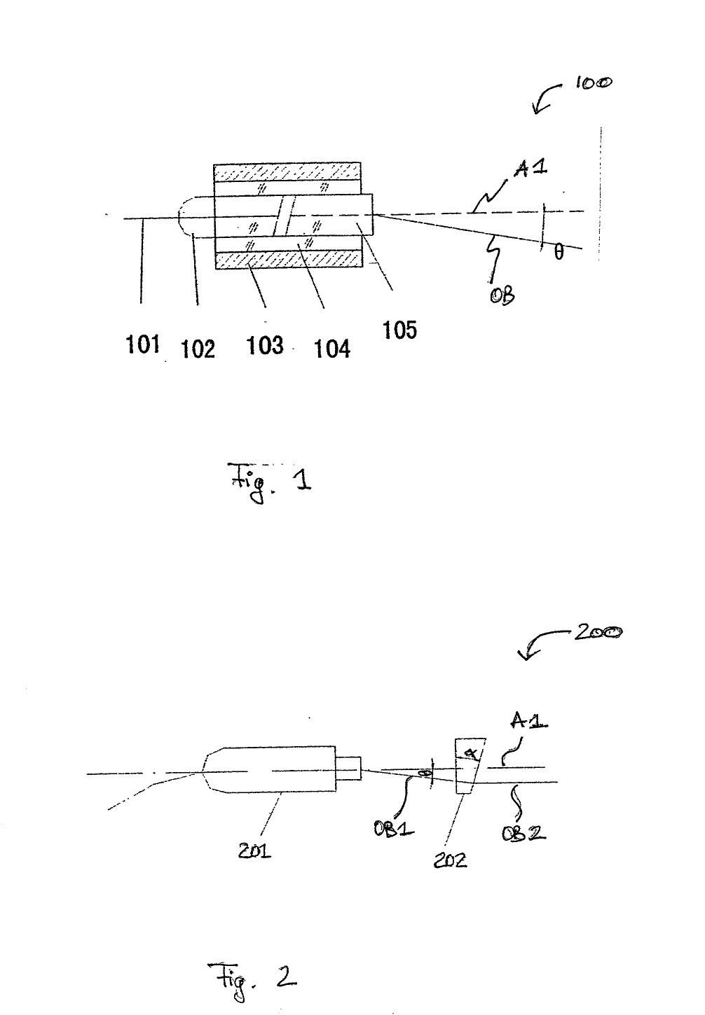

Reference is now being made to FIG. 1 showing a schematic side view of a typical optical collimator 100 including an optical fiber 101 supported in a ferrule 102, and a lens 105. The lens 105 and the fiber 101 in ferrule 102 are supported in a collimator housing which includes a glass layer 104 and a metal layer 103. It is noted that the optical axes of the fiber 101 and the lens 105 are parallel to each other and aligned along an axis A1 of the optical collimator 100. As can be seen from FIG. 1, an output beam OB exits collimator 100 by making an angle θ with the axis A1 of collimator 100. Evidently, it is desirable to make output beam OB parallel to the axis A1 in order to reduce coupling losses between collimator 100 and a respective other optical element.

FIG. 2 shows a schematic presentation of an optical collimator assembly 200 in accordance with the present invention. Collimator assembly 200 comprises a collimator 201 and a light transmissive element 202, such as wedge, disposed to receive the output beam of light OB1 from the collimator 201 to correct an angular deviation so that the output beam OB2 exiting the wedge 202 is parallel to the axis A1 of collimator 201. Output beam OB1 makes an angle θ with the axis A1 of collimator 201. Typically, this angle θ is smaller than 1 degree, and in dependence upon θ the wedge is designed so as to compensate the angular deviation. The wedge 202 has a wedge angle α as shown in FIG. 2. The wedge angle α can be calculated as follows:

$$α = \frac{θ}{n - 1}$$

wherein n is the refractive index of the wedge 202.

If the angle of deviation theta θ is larger than 1 degree, the above equation can still be used to design the wedge with respect to its wedge angle alpha a and refractive index n to correct the angular deviation θ of a light beam exiting collimator 201. In the case that the above equation does not provide sufficient accuracy for determining the wedge angle alpha α, Snell's law is applied to determine the wedge angle alpha α more accurately.

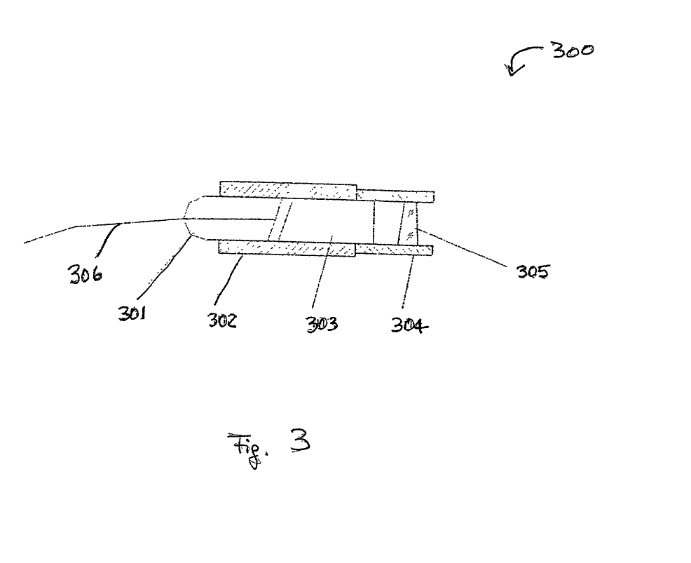

FIG. 3 shows a schematic presentation of a collimator assembly 300 in accordance with the present invention wherein a wedge 305 is supported in a wedge holder 304. Wedge holder 304 is fastened to a collimator housing 302 which holds collimating lens 303 and fiber 306 in ferrule 301.

Turning now to FIG. 4, a schematic side view of a collimator assembly 400 is shown in accordance with another embodiment of the present invention wherein two wedges 403 and 404 are used to correct an angular deviation theta θ of an output beam OB1 exiting a collimator 402. After passing through wedges 403 and 404 an output beam OB2 is parallel to an axis A1 of collimator 402. As is seen from FIG. 4, a fiber 401 is arranged in the collimator 402 such that its axis lies along axis A1.

Wedge 403 has a wedge angle alpha α and wedge 404 has a wedge angle beta β. The sum of both wedge angles alpha α and beta β is defined as angle γ and depends upon a relative position of wedge 403 to wedge 404. Both wedges are designed such that an angular deviation θ is compensated when a beam of light passes therethrough. Thus, if θ is known, the angle γ can be calculated using theta θ to correct a certain angular deviation of theta θ. Both angles theta θ and gamma γ can be related by the following equation:

$$γ = \frac{θ}{n - 1}$$

wherein n is a refractive index of the wedge, assuming both wedges have a same refractive index. If the refractive index of wedge 403 is different from the refractive index of wedge 404, the equation is adapted accordingly.

The use of two wedges is advantageous as it allows a simple correction for any angular deviation by changing the relative angle between the wedges, i.e. a rotational angle φ, to correct a certain angular deviation theta θ of a light beam exiting a collimator. The slanted end face of the wedges and a relative position between the wedges causes a re-alignment of an output beam to be parallel to an axis of the collimator. By changing the relative position of these wedges, i.e. rotational angle φ, a relative angle between the wedges can be found causing the output beam to come out parallel to an axis of the collimator assembly.

Thus, by varying the rotational angle between the wedges, gamma γ, the sum of the wedge angles α and β, can be varied to take the following values:

γ=α+β(φ=0°) to γ=α−β(φ=180°) and any value in between by rotating the wedges relative to each other between 0° and 180°.

In the case of a boundary condition wherein α=β, the sum of the wedge angles is varied from 0 to 2α.

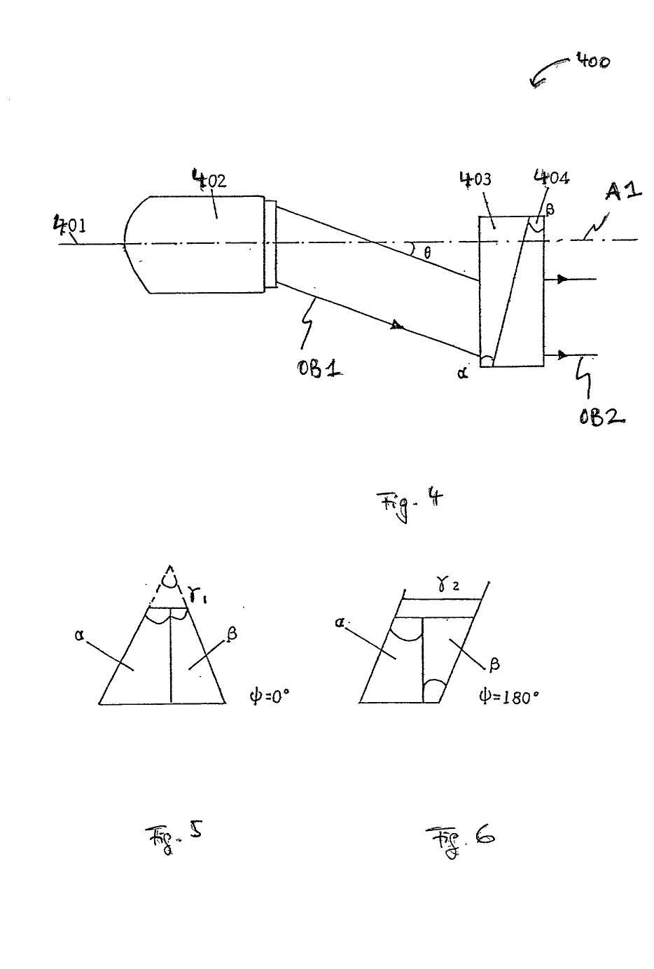

FIG. 5 shows a schematic side view of an alternative arrangement of two wedges wherein narrow ends and wider ends of the respective wedges abut on a same side resulting in a frustoconical/conical arrangement for a rotational angle of φ=0° and γ₁=α+β. In the embodiment presented in FIG. 4, the narrower ends and the wider ends of the wedges were disposed on respective opposite sides for a rotational angle of φ=0°. FIG. 6 shows a schematic side view of another arrangement of the wedges of FIG. 5 wherein the wedges are rotated by 180° and γ₂=α−β.

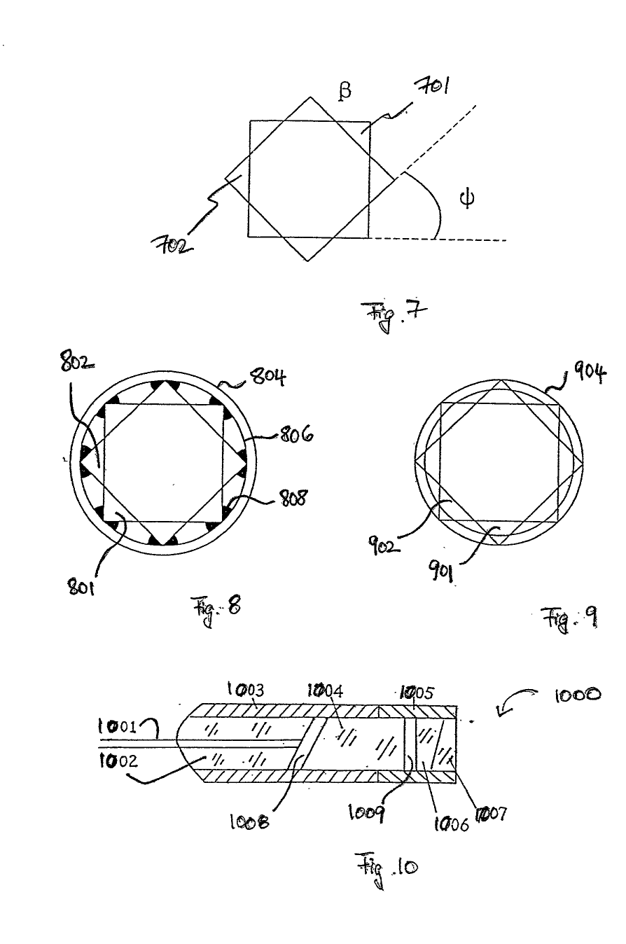

FIG. 7 shows a schematic front view of two wedges 701 and 702 in accordance with the present invention to show the relative angle of rotation φ between the wedges more clearly.

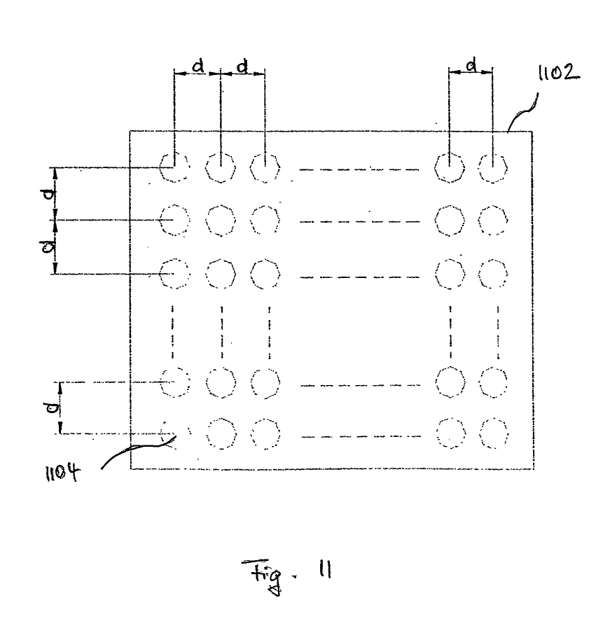

Once the angular deviation is corrected by providing a respective wedge or pair wedges, they can be fastened in the collimator housing. FIGS. 8 and 9 show a schematic front view of a collimator housing in accordance with the invention wherein two wedges are fastened within the housing. The embodiment presented in FIG. 8 shows how two wedges 801 and 802 are fastened inside a sleeve 806 in the collimator housing 804 after the wedges 801 and 802 are aligned with a respective relative rotational angle φ. The wedges 801 and 802 are fastened in the sleeve by gluing the corners of the wedges to the sleeve with an epoxy adhesive 808. Each collimator may cause a different angular deviation so that the wedges are first relatively rotated with respect to each other to provide a respective compensation for the angular deviation of a respective collimator before the wedges are fastened in the housing. Once an output beam is made parallel to an axis of the collimator, or a lens or lens system within the collimator, the relative rotational angle φ between the wedges is retained and the wedges are fixed in the collimator housing.

FIG. 9 shows a schematic front view of a collimator housing wherein two wedges 901 and 902 are arranged within the housing 904 and are fastened to the housing by attaching the corners of the wedges 901 and 902 to the housing 904.

Turning now to FIG. 10, a schematic side view of a collimator assembly 1000 in accordance with the invention is shown. The embodiment presented in FIG. 10 comprises a wedge holder 1005 supporting wedges 1006 and 1007. Wedge holder 1005 is fastened to the collimator housing 1003. The collimator housing 1003 holds a fiber 1001 in a sleeve 1002 and a collimating lens 1004. Collimator assembly 1000 further includes a gap 1008 between an end of fiber 1001 and the collimating lens 1004, and a gap 1009 between the collimating lens 1004 and the wedge 1006. Both gaps 1008 and 1009 can be filled with air or an epoxy material, for example.

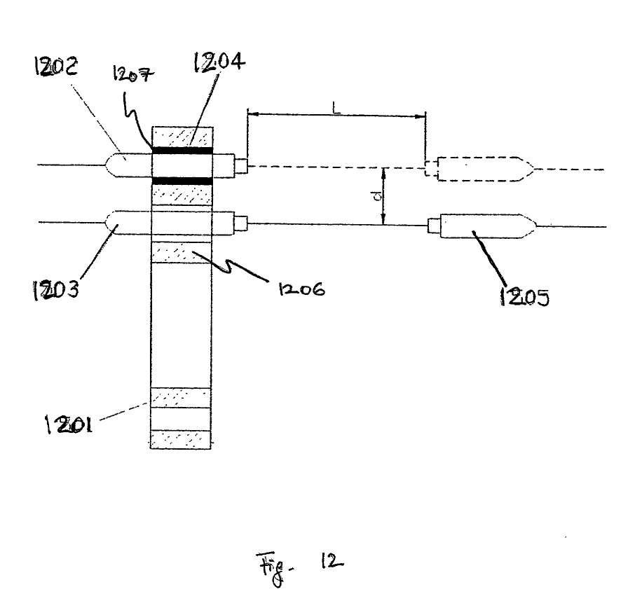

FIG. 11 shows a schematic top view of a substrate 1102 comprising an array of openings 1104 therethrough. The openings 1104 are separated from each other by a distance d. These openings are provided to receive collimators so as to prepare an array of collimators. In accordance with another embodiment of the invention it is an object of the invention to make the beams exiting each collimator in an array parallel to each other. In order to achieve this, each collimator is individually corrected. This done by providing a collimator assembly in accordance with the present invention comprising either a single wedge or double wedges. The advantage of using a double wedge, as was stated above, is that an angular deviation θ can be corrected from α+β to α−β by changing the relative rotational angle of the wedges with respect to each other.

Reference is now being made to FIG. 12 showing a schematic side view of a collimator array 1201 and a standard collimator 1205 to align individual collimators 1202 and 1203, for example, in an array. As can be seen from FIG. 12, collimator 1202 is positioned in an opening 1204 in the substrate 1206. The standard collimator 1205 is placed across from collimator 1202 at a distance L. The direction of the beam exiting from the standard collimator is known, and hence collimator 1202 is adjusted so as to minimize a coupling loss between the collimators. Once the minimum coupling loss position is determined, collimator 1202 is fixed within the opening by means of an epoxy adhesive 1207, for example. After collimator 1202 is adjusted, the standard collimator is moved downward by a distance “d” corresponding to the distance by which the individual collimators are separated in the array. Again, collimator 1203 is positioned so as to yield a minimum coupling loss between the standard collimator and collimator 1203. This process is continued until all collimators in an array are aligned to be parallel to each other. However, for ease of illustration only two collimators 1202 and 1203 are presented in FIG. 12.

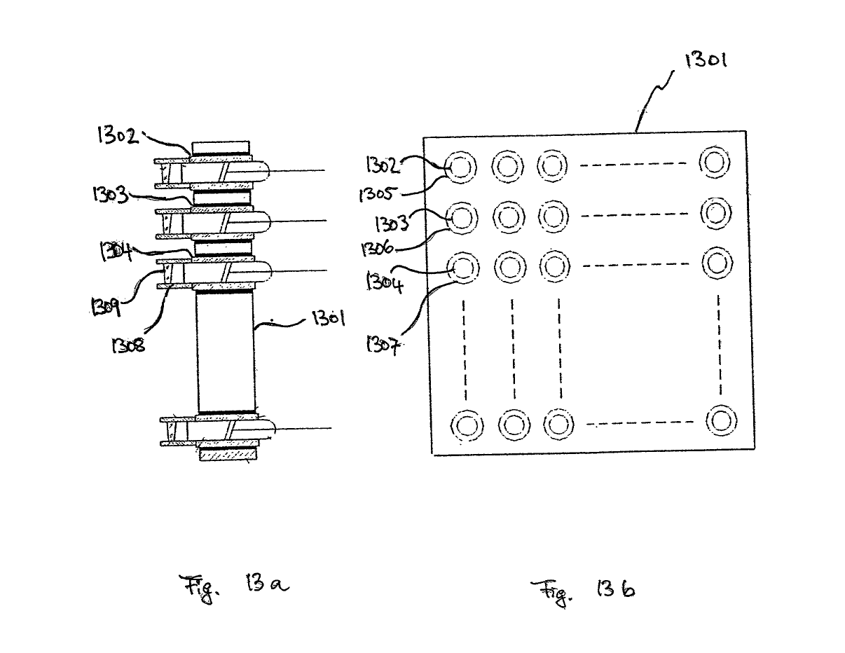

FIGS. 13a and 13b show a schematic side and top view, respectively, of an array of collimators 1301 in accordance with another embodiment of the present invention wherein an angular deviation of an output beam is corrected for each collimator of the array. Collimator assemblies 1302, 1303, and 1304 are placed in respective openings 1305 to 1307 of array 1301. As can be seen from FIGS. 13a and 13b, each of the collimators includes a wedge holder 1308 for supporting a wedge 1309 to correct an angular deviation of an output beam to make it parallel to an axis of the respective collimator. For ease of illustration, FIG. 13a shows a single wedge for correcting an angular deviation of an output beam of the respective collimator. If desired, a double wedge is arranged in the wedge holder 1308 for correcting an angular deviation of an output beam as was discussed in conjunction with FIGS. 4 to 10. After the collimator assemblies are placed in the openings of the array, an alignment procedure is performed to make all of the collimator assemblies parallel to one another. A possible alignment procedure was described heretofore with respect to FIG. 12.

In the case of an optical array, it is desired to make all of the output beams from the various collimators parallel to each other. Hence, respective wedges or double wedges are selected and attached to the respective collimators in order to correct an angular deviation of the individual output beams from each collimator and to make them parallel to one another.

In accordance with a further embodiment of the present invention, the wedge or wedges to correct the angular deviation of output beams from collimators can be made from any light-transmissive material, such as a piece of glass or plastic. Furthermore, the light-transmissive element is absent optical power.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. An optical collimator assembly comprising:
an optical fiber for transmitting a beam of light;
a lens for substantially collimating a beam of light received from the optical fiber; and
a first light transmissive element disposed to receive a beam of light from the lens for correcting an angular deviation in a beam of light received from the lens, said angular deviation being a deviation from a common axis of the optical collimator assembly.

2. The optical collimator assembly as defined in claim 1 wherein the first light-transmissive element is essentially absent optical power and birefringence.

3. The optical collimator assembly as defined in claim 2 wherein the first light-transmissive element has two non-parallel surfaces defining a first angle therebetween, one of the two non-parallel surfaces being a receiving surface for receiving a beam of light from the lens and the other one of the two non-parallel surfaces being a transmissive surface for transmitting the beam of light.

4. The optical collimator assembly as defined in claim 3 wherein the first light-transmissive element is a first wedge.

5. The optical collimator assembly as defined in claim 4 wherein the first angle is determined from a first relationship including the angular deviation of a beam of light exiting the lens and a refractive index of the first wedge.

6. The optical collimator assembly as defined in claim 4 further comprising a wedge holder for containing said first wedge and a collimator housing for containing said lens and optical fiber, said wedge holder being fastened to the collimator housing.

7. The optical collimator assembly as defined in claim 3 further comprising a second light-transmissive element having two non-parallel surfaces defining a second angle therebetween, one of the two non-parallel surfaces being a receiving surface for receiving the beam of light from the first light-transmissive element and the other one of the two non-parallel surfaces being a transmissive surface for transmitting the beam of light, said first and second light-transmissive element being disposed such that the transmissive face of the first light-transmissive element abuts with the receiving surface of the second light-transmissive surface.

8. The optical collimator assembly as defined in claim 7 wherein the first and the second light-transmissive element are disposed about a common rotational axis defining a relative rotational angle between the first and the second light-transmissive element, said common rotational axis being substantially parallel to the common axis of the optical collimator assembly.

9. The optical collimator assembly as defined in claim 8 wherein the relative rotational angle is a sum of the first and the second angle.

10. The optical collimator assembly as defined in claim 9 wherein the relative rotational angle is determined from a second relationship including the angular deviation of a beam of light exiting the lens and a refractive index of the first and the second wedge.

11. The optical collimator assembly as defined in claim 9 wherein the relative rotational angle is adjusted by relatively displacing the first and the second light-transmissive element about the common rotational axis.

12. The optical collimator assembly as defined in claim 10 further comprising a wedge holder for containing said first and second wedge and a collimator housing for containing said lens and optical fiber, said wedge holder being fastened to the collimator housing.

13. An array of collimators comprising the optical collimator assembly as defined in claim 6.

14. An array of collimators comprising the optical collimator assembly as defined in claim 12.

15. An optical collimator assembly comprising:
an optical fiber having an input end for receiving a beam of light and an output end for transmitting a beam of light;
an optical fiber sleeve for holding the optical fiber, wherein the optical fiber sleeve and the optical fiber have parallel longitudinal axes and coplanar output end surfaces;
a lens for substantially collimating a beam of light received from the output end of the optical fiber; and
a first light-transmissive powerless non-birefringent element having a first light-receiving face and an opposed first light-transmitting face, said first receiving and first transmitting face being non-parallel, the light-transmissive powerless non-birefringent element so located and oriented so as to correct an angular deviation in a beam of light exiting the lens to provide an output beam that is substantially parallel to a common axis of the optical collimator assembly.

16. The optical collimator assembly as defined in claim 15 further comprising a second light-transmissive powerless non-birefringent element having a second light-receiving face and an opposed second light-transmitting face, said second receiving and second transmitting face being non-parallel, the second light-transmissive powerless non-birefringent element being so disposed that the first transmitting face abuts the second receiving face, said first and second light-transmissive powerless non-birefringent element being disposed about a common rotational axis defining a relative rotational angle between the first and the second light-transmissive powerless non-birefringent element, said common rotational axis being substantially parallel to the common axis of the optical collimator assembly.

17. The optical collimator assembly as defined in claim 16 wherein the relative rotational angle is adjusted by relatively displacing the first and the second light-transmissive powerless non-birefringent element about the common rotational axis.

18. The optical collimator assembly as defined in claim 16 further comprising a housing for securely holding the fiber sleeve with the optical fiber, the lens, and the first light-transmissive powerless non-birefringent element.

19. The optical collimator assembly as defined in claim 18 wherein the housing is further securely holding the second light-transmissive powerless non-birefringent element.
